(19) United States
(12) Patent Application Publication
(10) Pub. No.: US 2007/0223847 A1
(43) Pub. Date: Sep. 27, 2007

(54) Hydrodynamic bearing having additional reservoir

(75) Inventor: Tae Hyeong Lim, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/724,259

(22) Filed: Mar. 15, 2007

(30) Foreign Application Priority Data
Mar. 27, 2006 (KR) 10-2006-0027515

(51) Int. Cl. F16C 32/06

(52) U.S. Cl. 384/100

(57) ABSTRACT

Disclosed herein is a hydrodynamic bearing which has improved ability to efficiently seal fluid (lubricant), which generates dynamic pressure. The hydrodynamic bearing provides a fluid storage space that couples a fluid reservoir with a hydrodynamic space, in addition to a fluid reservoir defined by a spacer and a cover. The fluid storage space has a cross-section that gradually tapers in a fluid supply direction, thus serving as an additional fluid reservoir for sealing fluid and supplying the fluid to the hydrodynamic space, when necessary. Further, unlike the prior art, where a fluid surface is controlled in a relatively narrow fluid reservoir, the fluid surface can be controlled in a relatively wide fluid storage space, and air bubbles generated in the hydrodynamic space can be easily discharged to the outside, thus affording convenience when the hydrodynamic bearing is used.

### CROSS REFERENCE TO RELATED APPLICATION(S)

This application claims the benefit of Korean Patent Application No. 10-2006-0027515, filed on Mar. 27, 2006, entitled “Hydrodynamic bearing with an additional reservoir”, which is hereby incorporated by reference in its entirety into this application.

### BACKGROUND OF THE INVENTION

1. Field of the Invention

The present invention relates generally to hydrodynamic bearings and, more particularly, to a hydrodynamic bearing having an additional fluid reservoir, which has improved ability to efficiently seal fluid (lubricant), which generates dynamic pressure.

2. Description of the Related Art

The sealing of fluid (lubricant) is one of the most important characteristics required for a hydrodynamic bearing. Thus, extensive technologies relating to the control of fluid in the hydrodynamic bearing, including the sealing characteristics of the fluid injected into the hydrodynamic bearing, the injection of the fluid, and the control of a fluid surface, are required. However, only some of the technologies relating to fluid control in the hydrodynamic bearing are known.

For example, a fluid sealing structure for hydrodynamic bearings is disclosed in Japanese Patent Laid-Open Publication No. Hei8-210364, which was filed by Sankyo Seiki Mfg. Co., Ltd. of Japan, and was published on Aug. 20, 1996, and Japanese Patent Laid-Open Publication No. 2004-36892 which was filed by Minebea Co., Ltd. of Japan and was published on Feb. 5, 2004. Hereinafter, the fluid sealing structure will be described in brief with reference to the accompanying drawings.

As shown in FIG. 1, a conventional sealing structure (Prior Art 1) includes a rotary member 10 and a stationary member 20 fastened to the rotary member 10, with a hydrodynamic space 30 defined between the rotary member 10 and the stationary member 20. A gap variation part A is formed at an open end of the hydrodynamic space 30 and is inclined at a predetermined angle α. FIG. 1 shows only part of the sealing structure around a central axis C.

According to the prior art, fluid F is injected into the hydrodynamic space 30 between the rotary member 10 and the stationary member 20, and the surface Fs of the fluid is maintained at the gap variation part A, thus allowing the fluid to be stably retained in the hydrodynamic bearing. The conventional sealing structure is problematic in that the volume of the gap variation part A is relatively small, so that the fluid is evaporated or leaks out from the hydrodynamic bearing after the hydrodynamic bearing having such a sealing structure has been used for a lengthy period of time, thus resulting in the lack of fluid in the hydrodynamic bearing.

Further, as shown in FIG. 2, another conventional sealing structure (Prior Art 2) includes a rotary member 110 which is provided with a flange 112, a stationary member 120 which surrounds the rotary member 110, a housing 130 which surrounds the stationary member 120 and is provided with a cover 132 to cover the upper surface of the stationary member 120, a support part 140 which is provided in the lower portion of the housing 130 and supports the rotary member 110, and a spacer 150 which is interposed between a cover 132 of the housing 130 and the upper surface of the stationary member 120.

A very narrow hydrodynamic space 160 is defined between the rotary member 120 and the corresponding parts, and between the flange 112 and the corresponding parts. Fluid, such as a lubricant, is injected into the hydrodynamic space 160, thus supporting the rotary member 110 in a non-contact manner by dynamic pressure.

In the conventional sealing structure, fluid is injected through a fluid reservoir 162 which is defined between the cover 132 and the spacer 150. The injected fluid flows through an opening 152 formed at a predetermined position in the spacer 150, and through a gap between the spacer 150 and the stationary member 120, into the hydrodynamic space 160. The fluid injected into the hydrodynamic space 160 supports the rotary motion of the rotary member 110 in a non-contact manner through dynamic pressure.

The conventional sealing structure is problematic in that the fluid is injected through the relatively narrow fluid reservoir 162 defined between the cover 132 and the spacer 150, so that it is difficult to inject the fluid. Further, since it is difficult for a worker to confirm the amount of fluid that is injected because of the cover 132, it is difficult to control the injection of the fluid and a fluid surface. Further, the area of the fluid contacting the exterior is limited to the fluid reservoir 162, so that it is difficult for air bubbles generated in the hydrodynamic space 160 to be discharged to the outside.

As such, the conventional sealing structure is problematic in that the volume of the fluid reservoir 162 is relatively small, so that the fluid in the hydrodynamic bearing is evaporated or discharged to the outside after the hydrodynamic bearing has been used for a lengthy period of time, thus resulting in a lack of fluid in the hydrodynamic bearing.

Further, the conventional sealing structure is problematic in that, when air bubbles are generated in the fluid injected into the hydrodynamic space, the air bubbles are not discharged to the outside but remain in the hydrodynamic space, so that the ability of the bearing to use dynamic pressure is deteriorated.

### SUMMARY OF THE INVENTION

Accordingly, the present invention has been made keeping in mind the above problems occurring in the prior art, and an object of the present invention is to provide a hydrodynamic bearing, which is capable of stably supplying a proper amount of fluid to hydrodynamic space, and easily controlling the surface of fluid injected into the hydrodynamic space.

Another object of the present invention is to provide a hydrodynamic bearing, which allows air bubbles, caused by fluid circulating in the hydrodynamic space, to be easily discharged to the outside, thus maintaining the ability of the bearing to efficiently use dynamic pressure.

In order to accomplish the above objects, the present invention provides a hydrodynamic bearing including a rotary member which rotates about a central axis, an annular stationary member which is fastened to a side surface of the rotary member and is located in a radial direction relative to the rotary member, an annular housing which has a hollow portion for receiving the stationary member therein and has a cover to cover an upper surface of the stationary member, a support member which is fastened to a lower end of the hollow portion of the housing and supports a lower portion of the rotary member, and a spacer which is interposed between the upper surface of the stationary member and the cover, thus defining a fluid reservoir having a tapered cross-section between the spacer and the cover. In this case, a very narrow hydrodynamic space is formed along the side surface and the lower portion of the rotary member, and the rotary member is supported in a non-contact manner by hydrodynamic action of fluid in the hydrodynamic space. A fluid storage space is further provided on a side surface of the stationary member and couples the fluid reservoir with the hydrodynamic space via a lower surface of the stationary member, the fluid storage space serving as an additional fluid reservoir.

The fluid storage space comprises a groove which is formed in at least one surface of a pair of facing surfaces of the stationary member and the housing.

The fluid storage space is formed such that a cross-section thereof facing the fluid reservoir is larger than a cross-section thereof opposite the fluid reservoir. Preferably, the fluid storage space is formed such that the cross-section thereof is gradually reduced in a direction from the fluid reservoir to an opposite end.

Part of the spacer contacting the fluid storage space is cut, thus providing a passage coupling the fluid reservoir with the fluid storage space.

Further, the stationary member further comprises at least one fluid circulating space in a direction parallel to the central axis, the fluid circulating space coupling the upper surface of the stationary member with the lower surface of the stationary member. An upper groove is formed on the upper surface of the stationary member in a direction from the fluid circulating space to the central axis. The upper groove serves as a passage for the fluid to flow between the cover and the upper surface of the stationary member.

Further, the fluid circulating space comprises a groove which is formed in at least one surface of a pair of facing surfaces of the stationary member and the housing, or comprises at least one through hole passing through the stationary member.

The rotary member has on a lower portion thereof a flange which protrudes radially from the rotary member.

Further, in order to accomplish the above objects, the present invention provides a hydrodynamic bearing including a rotary member which rotates about a central axis, an annular stationary member which is fastened to a side surface of the rotary member and is located in a radial direction relative to the rotary member, an annular cover which covers an upper surface of the stationary member, a support member which is fastened to a lower end of the stationary member and supports a lower portion of the rotary member, and a spacer which is interposed between the upper surface of the stationary member and the cover, thus defining a fluid reservoir having a tapered cross-section between the spacer and the cover. In this case, a very narrow hydrodynamic space is formed along the side surface and the lower portion of the rotary member, and the rotary member is supported in a non-contact manner by hydrodynamic action of fluid in the hydrodynamic space. A fluid storage space passes through the stationary member in a direction parallel to the central axis so as to couple the fluid reservoir with the hydrodynamic space.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional sealing structure for hydrodynamic bearings;

FIG. 2 is a sectional view showing another conventional sealing structure for hydrodynamic bearings;

FIG. 3 is a sectional view showing a hydrodynamic bearing, according to the first embodiment of the present invention;

FIG. 4 is an exploded perspective view showing the hydrodynamic bearing of FIG. 3;

FIGS. 5A and 5B are sectional views showing the use of the hydrodynamic bearing of FIG. 3;

FIGS. 6A to 6C are sectional views taken along line VI-VI of FIG. 3 and showing fluid storage space;

FIG. 7 is a sectional view showing a hydrodynamic bearing, according to the second embodiment of the present invention;

FIG. 8 is an exploded perspective view showing the hydrodynamic bearing of FIG. 7;

FIGS. 9A to 9D are sectional views taken along line IX-IX of FIG. 7 and showing a fluid circulating space;

FIG. 10 is a sectional view showing a hydrodynamic bearing, according to the third embodiment of the present invention;

FIG. 11 is a sectional view showing a hydrodynamic bearing, according to the fourth embodiment of the present invention; and

FIG. 12 is an exploded perspective view showing the hydrodynamic bearing of FIG. 11.

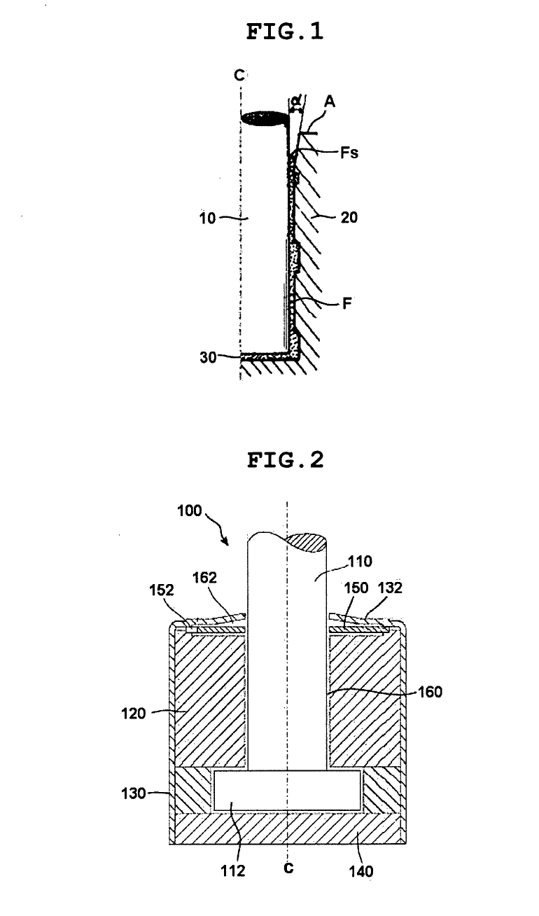

### DESCRIPTION OF THE PREFERRED EMBODIMENTS

Hereinafter, the preferred embodiments of the present invention will be described with reference to the accompanying drawings.

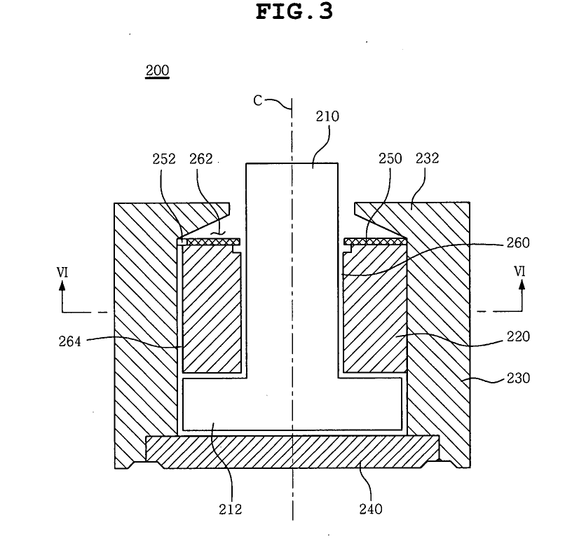

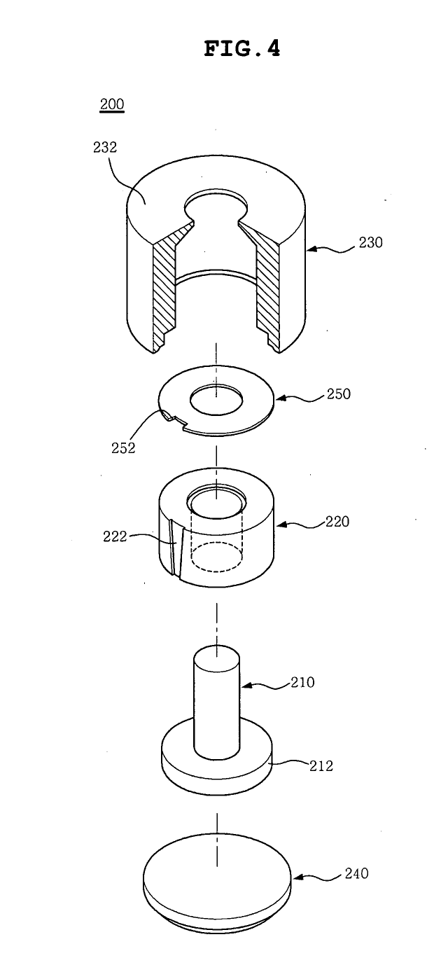

FIG. 3 is a sectional view showing a hydrodynamic bearing 200, according to the first embodiment of the present invention, and FIG. 4 is an exploded perspective view showing the hydrodynamic bearing of FIG. 3. Referring to FIGS. 3 and 4, the construction and use of the hydrodynamic bearing 200 according to the first embodiment of the invention will be described.

The hydrodynamic bearing 200 according to the invention includes a rotary member 210 which rotates about a central axis C. An annular stationary member 220 surrounds the rotary member 210. An annular housing 230 has a hollow portion which receives the stationary member 220 therein, and is provided with a cover 232 which covers the upper surface of the stationary member 220. A support member 240 is fastened to the lower portion of the hollow housing 230, and supports the lower portion of the rotary member 210. Further, a spacer 250 is interposed between the cover 232 of the housing 230 and the upper surface of the stationary member 220, thus defining a fluid reservoir 262 having a tapered cross-section between the cover 232 and the spacer 250.

According to this embodiment, a flange 212 is provided on the lower portion of the rotary member 210 in such a way as to protrude radially from the rotary member 210. In order to correspond to the shape of the flange 212, parts corresponding to the flange 212, for example, the housing 230 or the support member 240, must be formed.

In addition, the hydrodynamic bearing 200 of the invention has the fluid reservoir 262 and hydrodynamic space 260 around the stationary member 220. In a detailed description, fluid storage space 264 is further formed to communicate with the lower portion of the hydrodynamic space 260 through the lower portion of the stationary member 220. The fluid storage space 264 serves as an additional fluid reservoir.

The fluid reservoir must be formed to seal and store fluid using the space having the tapered cross-section, in addition to supplying the fluid into the hydrodynamic space 260 around the rotary member 210.

As shown in FIG. 4, the fluid storage space 264 is formed using a groove 222 which is formed in the side of the stationary member 220. When the groove 222 is coupled to the housing 230, the vertical fluid storage space is formed.

Further, part of the spacer 250 interposed between the fluid reservoir 262 and the fluid storage space 264 is cut, thus forming an opening 252. Thereby, fluid injected into the fluid reservoir 262 can be directly transmitted to the fluid storage space 264.

According to the invention, the cross-section at the end of the fluid storage space facing the fluid reservoir 262 is formed to be larger than the cross-section at the opposite end, thus serving as the additional fluid reservoir. As shown in FIG. 4, the groove 222 forming the fluid storage space 264 is formed to be wide at the upper end thereof and to be narrow at the lower end thereof, so that the fluid storage space 264 can serve as the additional fluid reservoir.

According to this embodiment, in order to provide the tapered cross-section to the fluid storage space 264, the width of the groove 222, formed in the circumferential surface of the stationary member 220, varies. However, the formation of the tapered fluid storage space is not limited to the above-mentioned method. Although not shown in the drawings, it is apparent that the tapered fluid storage space may be formed by changing the depth (direction from the surface of the stationary member to the central axis) of the groove which is formed in the side of the stationary member 220.

As such, the cross-section of the upper portion (e.g., the portion facing the fluid reservoir) of the fluid storage space 264 is larger than that of the lower portion (e.g., the portion facing the lower portion of the hydrodynamic space or the support member). Such a construction can serve to seal and store the fluid, like the fluid reservoir 262 defined by the spacer 250 and the cover 232. Further, according to the invention, the volume of the fluid storage space 264 is larger than that of the fluid reservoir 262. Thus, as compared to the case where only the fluid reservoir (e.g., 162 of FIG. 2) is present, the volume of fluid to be stored is increased. Thereby, the invention is advantageous in that fluid can be very stably maintained and supplied even when the hydrodynamic bearing is used for a longer time compared to a conventional hydrodynamic bearing.

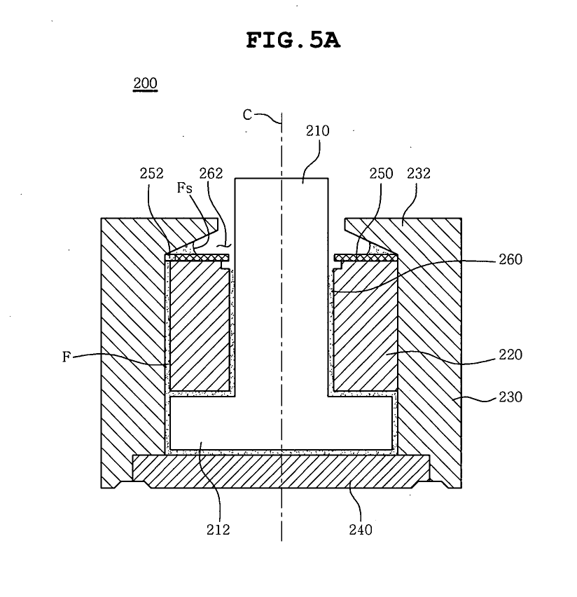

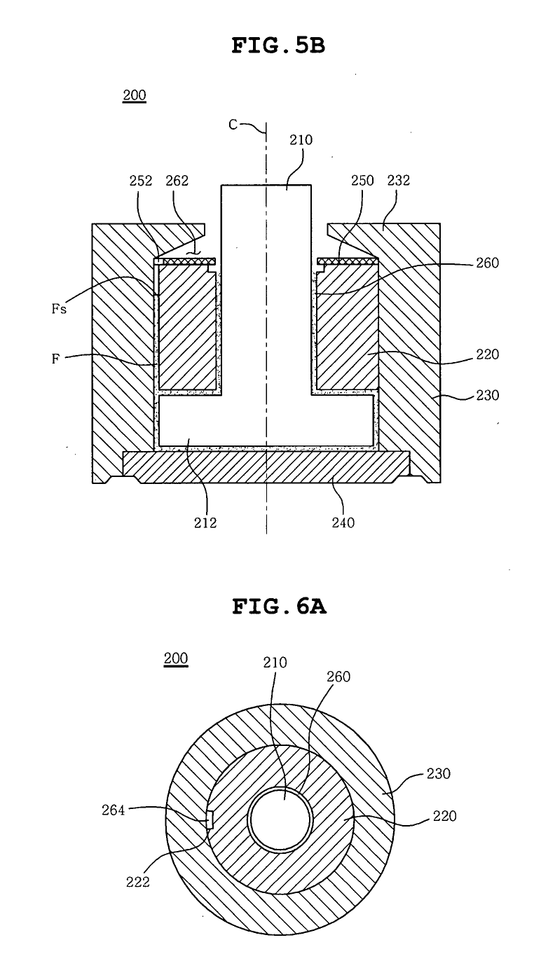

This can be clearly illustrated with reference to the use of the hydrodynamic bearing according to the invention, as shown in FIGS. 5A and 5B. For example, FIG. 5A shows the state right after the fluid is injected through the fluid reservoir 262. In the state where the fluid F is completely injected into the hydrodynamic space 260 and the fluid storage space 264, a fluid surface Fs is formed in the fluid reservoir 262.

In this case, the fluid storage space 264 simply serves as a passage coupling the hydrodynamic space 260 to the fluid reservoir 262.

Meanwhile, as shown in FIG. 5B, when the hydrodynamic bearing is used for a lengthy period of time, and the fluid is consequently reduced, or when the fluid is injected so that the fluid surface Fs is present in the fluid storage space 264, the fluid storage space itself can serve as another fluid reservoir. Therefore, the fluid storage space can desirably seal the fluid F and store a considerable amount of fluid, in addition to stably supplying a sufficient amount of fluid F into the hydrodynamic space 260.

Further, when the fluid in the hydrodynamic space 260 surrounding the rotary member 210 is evaporated or reduced, so that air bubbles are generated, the air bubbles can be easily discharged to the outside through the fluid storage space 264 and the fluid reservoir 262 coupled to the fluid storage space 264. Thus, such a construction can efficiently generate dynamic pressure using fluid.

As described above, if necessary, the fluid may be directly supplied to the fluid storage space 264, excluding the fluid reservoir 262 covered with the cover 232, thus stably replenishing the hydrodynamic space 260 with the fluid. As such, the fluid surface Fs is controlled not in the fluid reservoir 262 but in the fluid storage space 264, thus being convenient compared to the case where the fluid surface is controlled using a relatively narrow space (fluid reservoir).

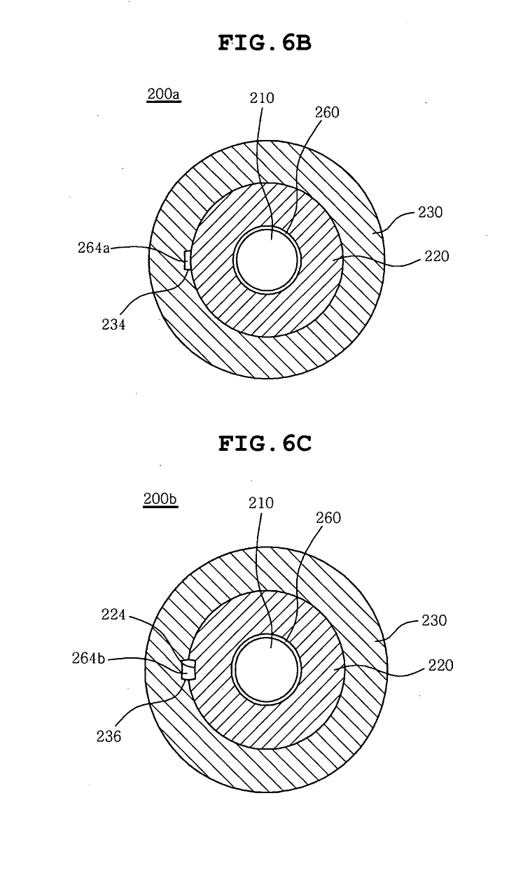

Meanwhile, the fluid storage space 264 according to the invention may be embodied in various shapes, as shown in FIGS. 6A to 6C. FIGS. 6A to 6C are sectional views taken along line VI-VI of FIG. 3, and illustrate the fluid storage space. Various shapes of fluid storage space will be described below with reference to the drawings.

FIG. 6A is a sectional view of the hydrodynamic bearing 200 having the fluid storage space 264 of FIG. 3. Among both contact surfaces of the stationary member 220 and the housing 230, the groove 222 is formed in the surface of the stationary member 220, thus defining the fluid storage space 264.

FIG. 6B shows a hydrodynamic bearing 200a, which is constructed so that a groove 234 is formed in the surface of a housing 230, thus defining fluid storage space 264a. Further, FIG. 6C shows a hydrodynamic bearing 200b, which is constructed so that grooves 236 and 224 are formed in surfaces of both the housing 230 and the stationary member 220, thus defining one fluid storage space 264b.

As such, the fluid storage space 264, 264a, or 264b according to the invention may have various shapes and positions, as long as the fluid storage space can serve as the additional fluid reservoir, together with the fluid reservoir 262 formed above the spacer 250.

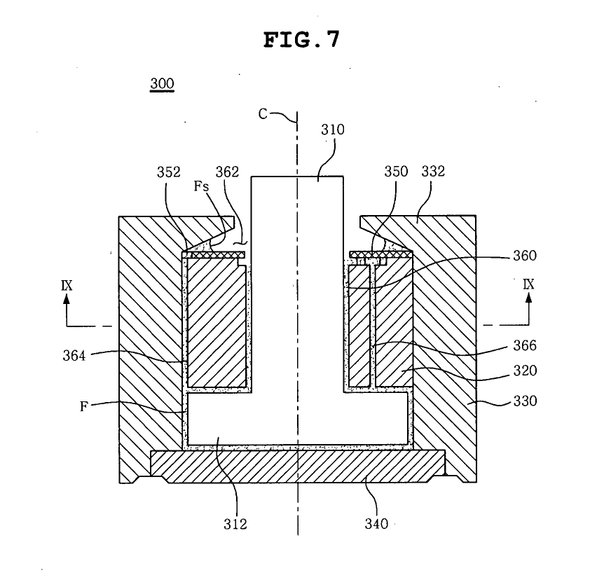

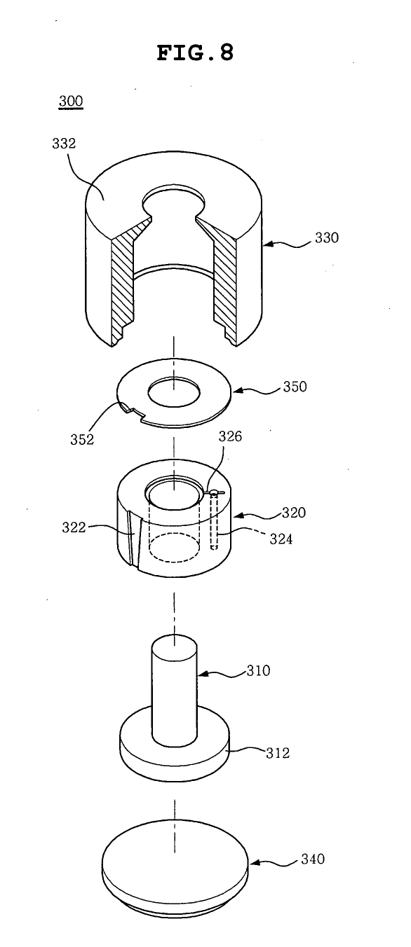

FIG. 7 is a sectional view showing a hydrodynamic bearing 300, according to the second embodiment of the present invention, and FIG. 8 is an exploded perspective view showing the hydrodynamic bearing of FIG. 7. The hydrodynamic bearing 300 shown in FIGS. 7 and 8 is equal to the hydrodynamic bearing of FIG. 3 except that this hydrodynamic bearing 300 further includes a fluid circulating space 366. Thus, the fluid circulating space 366 and the effect thereof will be described below in detail.

The hydrodynamic bearing 300 according to the invention includes a rotary member 310 which rotates about a central axis C. An annular stationary member 320 surrounds the rotary member 310. An annular housing 330 has a hollow portion which receives the stationary member 320 therein, and is provided with a cover 332 which covers the upper surface of the stationary member 320. A support member 340 is fastened to the lower portion of the hollow housing 330, and supports the lower portion of the rotary member 310. Further, a spacer 350 is interposed between the cover 332 of the housing 330 and the upper surface of the stationary member 320, thus defining a fluid reservoir 362 having a tapered cross-section between the cover 332 and the spacer 350.

According to this embodiment, a flange 312 is provided on the lower portion of the rotary member 310 to protrude radially from the rotary member 310. In order to correspond to the shape of the flange 312, parts corresponding to the flange 312, for example, the housing 330 and the support member 340, must be formed.

In addition, the hydrodynamic bearing 300 of the invention has the fluid reservoir 362 and hydrodynamic space 360 adjacent to the stationary member 320. In a detailed description, fluid storage space 364 is further formed to communicate with the lower portion of the hydrodynamic space 360 through the lower portion of the stationary member 320. The fluid storage space 364 serves as an additional fluid reservoir.

The fluid reservoir must be formed to seal and store fluid using the space having the tapered cross-section, in addition to supplying the fluid into the hydrodynamic space around the rotary member 310.

As shown in FIG. 8, the fluid storage space 364 is formed using a groove 322 which is formed in the side of the stationary member 320. When the groove 322 is coupled to the housing 330, the vertical fluid storage space is formed.

Further, part of the spacer 350 interposed between the fluid reservoir 362 and the fluid storage space 364 is cut, thus forming an opening 352. Thereby, fluid F injected through the fluid reservoir 362 can be directly transmitted to the fluid storage space 364.

The hydrodynamic bearing 300 of this embodiment further includes the fluid circulating space 366. The fluid circulating space 366 passes vertically through the stationary member 320, thus serving as a passage coupling the upper and lower surfaces of the stationary member 320 to each other. The fluid circulating space 366 allows the upper and lower portions of the hydrodynamic space 360 to maintain the same pressure. In this case, an upper groove 326 is formed on the upper surface of the stationary member 320 to correspond to the fluid circulating space 366. The upper groove 326 defines a fluid circulating path, which couples the hydrodynamic space 360 with the fluid circulating space 366.

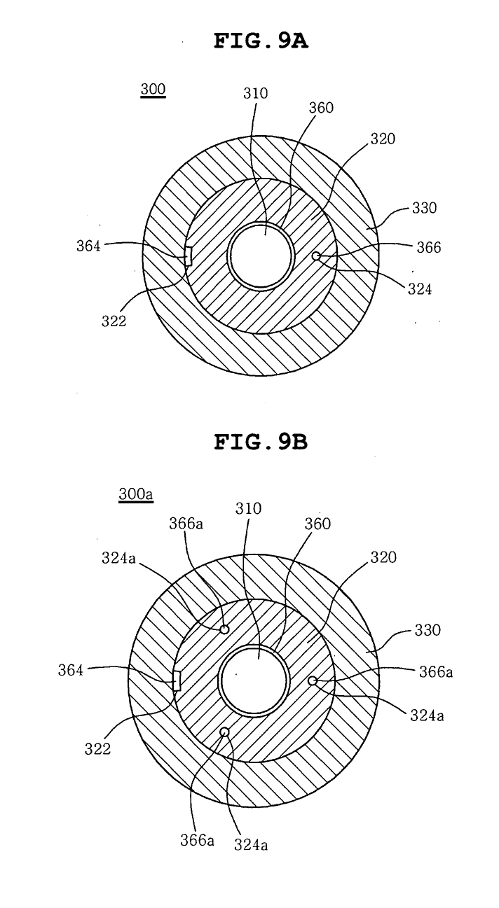

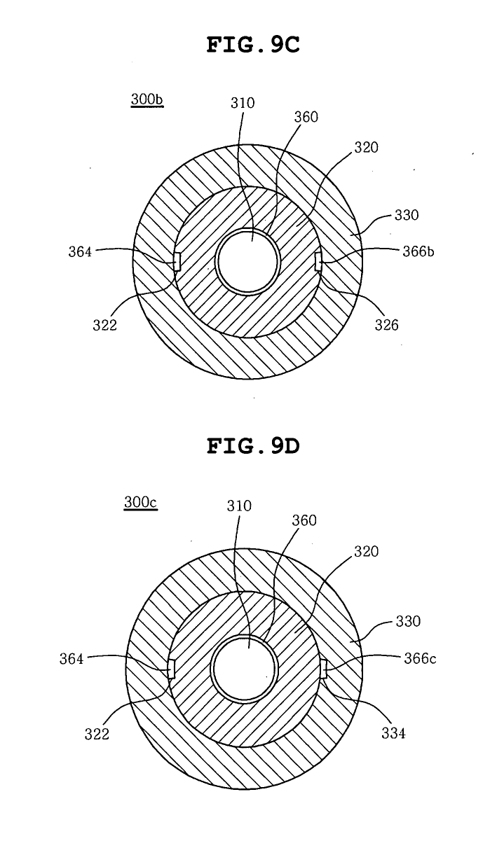

Further, FIGS. 9A to 9D are sectional views taken along line IX-IX of FIG. 7, and illustrate fluid circulating spaces having various shapes. The fluid circulating spaces will be described below with reference to FIGS. 9A to 9D.

FIG. 9A shows the hydrodynamic bearing 300 of FIG. 7, in which a through hole 324 is formed in a predetermined portion of the stationary member 320, thus defining the fluid circulating space 366. Referring to FIG. 9A, one through hole 324 is formed at a location opposite the fluid storage space 364, thus defining the fluid circulating space 366.

FIG. 9B shows a hydrodynamic bearing 300a having a plurality of fluid circulating spaces 366a by forming a plurality of through holes 324a in the stationary member 320. As shown in FIG. 9B, the number of fluid circulating spaces is not limited to a specific number.

FIGS. 9C and 9D show hydrodynamic bearings 300b and 300c which have fluid circulating spaces 366b and 366c, respectively, defined by grooves 326 and 334 which are formed on the sidewalls of the stationary member 320 and the housing 330. As such, the fluid circulating space formed in the hydrodynamic bearing may have one of various shapes.

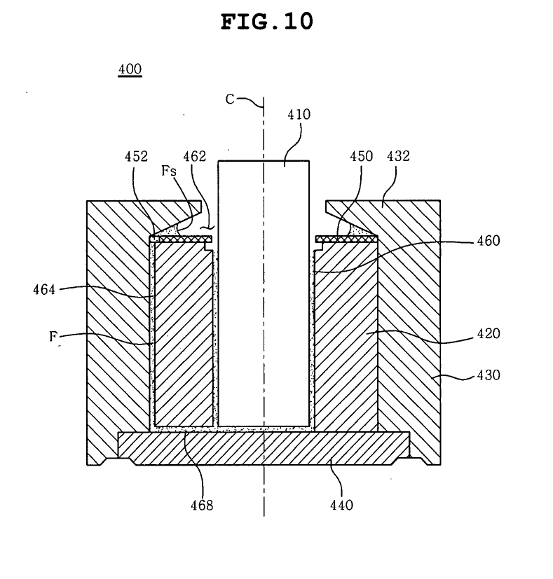

FIG. 10 is a sectional view showing a hydrodynamic bearing 400, according to the third embodiment of the present invention. Referring to FIG. 10, the hydrodynamic bearing 400 is characterized in that a flange is not provided on a rotary member 410. That is, unlike the above-mentioned embodiments, the flange is not provided on the rotary member 410, and other parts of the hydrodynamic bearing, such as a housing or a support member, are formed to correspond to the rotary member 410, which has no flange.

The construction of the hydrodynamic bearing 400 shown in FIG. 10 will be described in brief. The hydrodynamic bearing 400 according to the present invention includes a rotary member 410 which rotates about a central axis C. An annular stationary member 420 surrounds the rotary member 410. An annular housing 430 has a hollow portion which receives the stationary member 420 therein, and is provided with a cover 432 which covers the upper surface of the stationary member 420. A support member 440 is fastened to the lower portion of the hollow housing 430, and supports the lower portion of the rotary member 410. Further, a spacer 450 is interposed between the cover 432 of the housing 430 and the upper surface of the stationary member 420, thus defining a fluid reservoir 462 having a tapered cross-section between the cover 432 and the spacer 450.

In addition, the hydrodynamic bearing 400 of the invention has the fluid reservoir 462 and hydrodynamic space 460 adjacent to the stationary member 420. In a detailed description, a fluid storage space 464 is further formed to communicate with the lower portion of the hydrodynamic space 460 through the lower space (468; fluid coupling space) of the stationary member 420. The fluid storage space 464 serves as an additional fluid reservoir.

Further, part of the spacer 450 interposed between the fluid reservoir 462 and the fluid storage space 464 is cut, thus forming an opening 452. Thereby, fluid F injected through the fluid reservoir 462 can be directly transmitted to the fluid storage space 464.

Like the above-mentioned embodiments, the hydrodynamic bearing 400 of this embodiment is characterized in that the fluid storage space 464 is vertically formed to one side of the stationary member 420. Since the fluid storage space 464 serves as the additional fluid reservoir, the characteristics of the invention can be achieved.

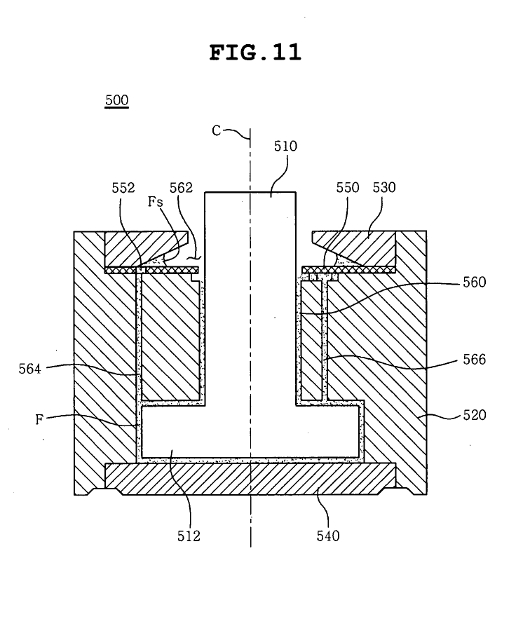

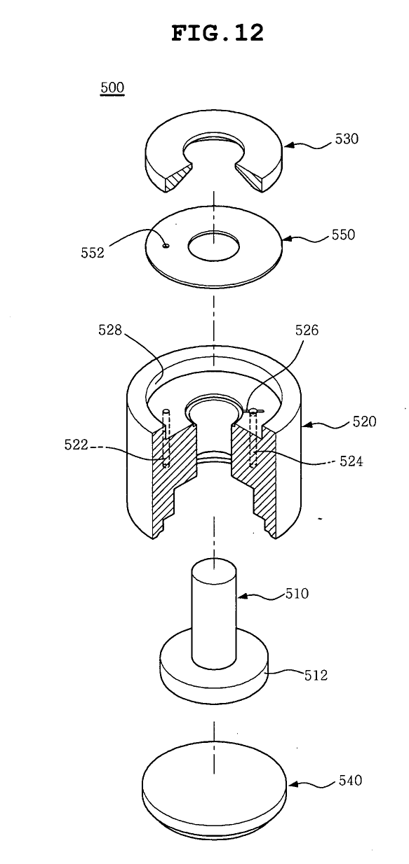

FIG. 11 is a sectional view showing a hydrodynamic bearing 500, according to the fourth embodiment of the present invention, and FIG. 12 is an exploded perspective view showing the hydrodynamic bearing of FIG. 11. The hydrodynamic bearing 500 of FIGS. 11 and 12 is characterized in that the housing 230, 330 or 430 is eliminated and a cover 530 is separately provided, unlike the hydrodynamic bearings 200, 300 and 400 of the above-mentioned embodiments. Thus, the basic construction and characteristics of this embodiment will be described below.

The hydrodynamic bearing 500 according to the present invention includes a rotary member 510 which rotates about a central axis C. An annular stationary member 520 surrounds the rotary member 510, with a step formed on the upper portion of the stationary member 520. A cover 530 covers the stepped upper portion of the stationary member 520. A support member 540 is fastened to the lower portion of the stationary member 520, and supports the lower portion of the rotary member 510. Further, a spacer 550 is interposed between the cover 530 and the stepped upper portion of the stationary member 520, thus defining a fluid reservoir 562 having a tapered cross-section between the cover 530 and the spacer 550.

Further, according to this embodiment, a flange 512 is provided on the lower portion of the rotary member 510 and protrudes radially from the rotary member 510. In order to correspond to the shape of the flange 512, parts corresponding to the flange 512, for example, the stationary member and the support member, must be formed.

In addition, the hydrodynamic bearing 500 of the invention has the fluid reservoir 562 and hydrodynamic space 560 adjacent to the stationary member 520. In a detailed description, a fluid storage space 564 is further formed so as to communicate with the lower portion of the hydrodynamic space through the lower portion of the stationary member 520. The fluid storage space 564 serves as an additional fluid reservoir.

The fluid reservoir must be formed to seal and store fluid using the space having the tapered cross-section, in addition to supplying the fluid into the hydrodynamic space around the rotary member 510.

As shown in FIG. 12, the fluid storage space 564 has the form of a through hole 522 which is formed at a predetermined position in the stationary member 520. The through hole 522 is formed to be parallel to the central axis C, so that the vertical fluid storage space is formed.

Further, part of the spacer 550 interposed between the fluid reservoir 562 and the fluid storage space 564 is cut, thus forming an opening 552. Thereby, fluid F, injected through the fluid reservoir 562, can be directly transmitted to the fluid storage space 564.

Meanwhile, unlike the above-mentioned embodiments, the fluid storage space according to this embodiment comprises the through hole formed in the stationary member 520. Thus, in order to provide different cross-sectional sizes to the upper and lower portions of the through hole, a machining means, such as a tapered drill (not shown), must be used. That is, since the drill itself is tapered and thus has different diameters at upper and lower portions, the cross-section of the upper portion of the through hole 522 formed in the stationary member 520 is large and the cross-section of the lower portion of the through hole 522 is small. More preferably, the through hole 522 may be formed to be gradually tapered in the direction from the upper end of the through hole to the lower end thereof.

As such, since the tapered through hole forms the fluid storage space 564 according to the invention, the fluid storage space 564 can seal and store fluid, in addition to serving as an additional fluid reservoir for supplying the fluid into the hydrodynamic space 560 around the rotary member 510.

The hydrodynamic bearing 500 further includes a fluid circulating space 566. The fluid circulating space 566 passes vertically through the stationary member 520, thus serving as a passage for coupling the upper and lower surfaces of the stationary member 520 to each other. Through the fluid circulating space 566, the upper and lower portions of the hydrodynamic space 560 can maintain the same pressure. In this case, an upper groove 526 is formed on the upper surface of the stationary member 520 to correspond to the fluid circulating space 566. The upper groove 526 defines a fluid circulating path, which couples the hydrodynamic space 560 with the fluid circulating space 566.

It is apparent that the fluid storage space 564 and the fluid circulating space 566 of the hydrodynamic bearing 500 according to this embodiment have various shapes, based on the above-mentioned hydrodynamic bearings 200, 300, and 400.

As described above, the hydrodynamic bearing according to the invention provides the fluid storage space as a passage for supplying fluid to the existing hydrodynamic space. In particular, the fluid storage space has a tapered cross-section, thus serving as an additional fluid reservoir when necessary.

That is, since fluid is supplied through the fluid storage space, a sufficient amount of fluid in the fluid storage space can be stably supplied to the hydrodynamic space, even when the hydrodynamic bearing is used for a lengthy period of time or the fluid is evaporated, so that the amount of fluid is reduced. The fluid storage space has a tapered cross-section, so that the fluid storage space can seal the fluid therein and serve as an additional fluid reservoir.

Further, even when air bubbles are generated in the hydrodynamic space, the air bubbles are easily discharged through the fluid storage space to the outside, thus preventing the dynamic-pressure generating efficiency of the hydrodynamic space from being reduced by the air bubbles.

As described above, the present invention provides a hydrodynamic bearing, which provides a fluid storage space that couples a fluid reservoir with a hydrodynamic space, in addition to a fluid reservoir defined by a spacer and a cover, and in which the fluid storage space has a cross-section that gradually tapers in a fluid supply direction, thus serving as an additional fluid reservoir for sealing fluid and supplying the fluid to the hydrodynamic space, when necessary. Further, unlike the prior art, where a fluid surface is controlled in a relatively narrow fluid reservoir, the fluid surface can be controlled in a relatively wide fluid storage space, and air bubbles generated in the hydrodynamic space can be easily discharged to the outside, thus affording convenience when the hydrodynamic bearing is used.

What is claimed is:

1. A hydrodynamic bearing, comprising:
a rotary member rotating about a central axis;
an annular stationary member fastened to a side surface of the rotary member and located in a radial direction relative to the rotary member;
an annular housing having a hollow portion for receiving the stationary member therein, and having a cover to cover an upper surface of the stationary member;
a support member fastened to a lower end of the hollow portion of the housing, and supporting a lower portion of the rotary member; and
a spacer interposed between the upper surface of the stationary member and the cover, thus defining a fluid reservoir having a tapered cross-section between the spacer and the cover, wherein
a very narrow hydrodynamic space is formed along the side surface and the lower portion of the rotary member, and the rotary member is supported in a non-contact manner by hydrodynamic action of fluid in the hydrodynamic space, and
fluid storage space is further provided on a side surface of the stationary member and couples the fluid reservoir with the hydrodynamic space via a lower surface of the stationary member, the fluid storage space serving as an additional fluid reservoir.

2. The hydrodynamic bearing as set forth in claim 1, wherein the fluid storage space comprises a groove which is formed in at least one surface of a pair of facing surfaces of the stationary member and the housing.

3. The hydrodynamic bearing as set forth in claim 2, wherein the fluid storage space is formed such that a cross-section thereof facing the fluid reservoir is larger than a cross-section thereof opposite the fluid reservoir.

4. The hydrodynamic bearing as set forth in claim 3, wherein the fluid storage space is formed such that the cross-section thereof is gradually reduced in a direction from the fluid reservoir to an opposite end.

5. The hydrodynamic bearing as set forth in claim 1, wherein part of the spacer contacting the fluid storage space is cut, thus providing a passage coupling the fluid reservoir with the fluid storage space.

6. The hydrodynamic bearing as set forth in claim 1, wherein the stationary member further comprises at least one fluid circulating space in a direction parallel to the central axis, the fluid circulating space coupling the upper surface of the stationary member with the lower surface of the stationary member.

7. The hydrodynamic bearing as set forth in claim 6, wherein an upper groove is formed on the upper surface of the stationary member in a direction from the fluid circulating space to a central axis of the stationary member, the upper groove serving as a passage for the fluid to flow between the cover and the upper surface of the stationary member.

8. The hydrodynamic bearing as set forth in claim 7, wherein the fluid circulating space comprises a groove which is formed in at least one surface of a pair of facing surfaces of the stationary member and the housing.

9. The hydrodynamic bearing as set forth in claim 7, wherein the fluid circulating space comprises at least one through hole passing through the stationary member.

10. The hydrodynamic bearing as set forth in claim 1, wherein the rotary member has on a lower portion thereof a flange which protrudes radially from the rotary member.

11. A hydrodynamic bearing, comprising:
a rotary member rotating about a central axis;
an annular stationary member fastened to a side surface of the rotary member and located in a radial direction relative to the rotary member;
an annular cover covering an upper surface of the stationary member;
a support member fastened to a lower end of the stationary member, and supporting a lower portion of the rotary member; and
a spacer interposed between the upper surface of the stationary member and the cover, thus defining a fluid reservoir having a tapered cross-section between the spacer and the cover, wherein
a very narrow hydrodynamic space is formed along the side surface and the lower portion of the rotary member, and the rotary member is supported in a non-contact manner by hydrodynamic action of fluid in the hydrodynamic space, and
a fluid storage space passes through the stationary member in a direction parallel to the central axis so as to couple the fluid reservoir with the hydrodynamic space.

12. The hydrodynamic bearing as set forth in claim 11, wherein the fluid storage space is formed such that a cross-section thereof is gradually reduced in a direction from the fluid reservoir to an opposite end.

13. The hydrodynamic bearing as set forth in claim 11, wherein part of the spacer contacting the fluid storage space is cut, thus providing a passage coupling the fluid reservoir with the fluid storage space.

14. The hydrodynamic bearing as set forth in claim 11, wherein the stationary member further comprises at least one fluid circulating space in a direction parallel to the central axis, the fluid circulating space coupling the upper surface of the stationary member with a lower surface of the stationary member.

15. The hydrodynamic bearing as set forth in claim 14, wherein upper and lower grooves are formed in the upper and lower surfaces of the stationary member in a direction from the fluid circulating space to a central axis of the stationary member, the upper and lower grooves serving as a passage for the fluid to flow.

16. The hydrodynamic bearing as set forth in claim 11, wherein the rotary member has on a lower portion thereof a flange which protrudes radially from the rotary member.
